(19) United States
(12) Patent Application Publication
(10) Pub. No.: US 2022/0166712 A1
(43) Pub. Date: May 26, 2022

(54) EDGE ROUTING BY LEAF SYSTEMS IN AN API GATEWAY

(71) Applicant: Intuit Inc., Mountain View, CA (US)

(72) Inventors: Karim Lakhani, San Diego, CA (US); Abhinit Kumar, Bangalore (IN); Laurent Benchimol, San Diego, CA (US); Krishna Vaishnav, San Diego, CA (US); Sweta Shyamsukha, Bangalore (IN); Anil Kumar Attuluri, San Diego, CA (US)

(73) Assignee: Intuit Inc., Mountain View, CA (US)

(21) Appl. No.: 17/102,030

(22) Filed: Nov. 23, 2020

(51) Int. Cl. H04L 12/771; H04L 12/66; G06F 9/54

(52) U.S. Cl. CPC H04L 45/56; G06F 9/547; H04L 12/66

(57) ABSTRACT

Systems and methods for routing requests in an application programming interface (API) gateway are disclosed. An example method may include receiving a request from a client at the API gateway, requesting routing information for the request from a routing service associated with the request, receiving the requested routing information from the routing service, the routing information determined based at least in part on the request and a client state associated with the request, and forwarding, from the API gateway, the request to a destination based on the routing information.

### TECHNICAL FIELD

This disclosure relates generally to methods for routing systems, and more specifically, to methods for configuring, reconfiguring, and operating Application Programming Interface (API) gateways.

### DESCRIPTION OF RELATED ART

Application Programming Interface (API) gateways are increasingly commonly deployed for routing requests within internet applications. API gateways typically function in a network as an interface between clients and a collection of backend services. The API gateway accepts requests, such as API calls, from the clients, determines how those requests should be routed to the backend services, and routes the requests. API gateways may also aggregate responses from the various backend services to generate a result for the requesting client. API gateways may perform additional functions including authentication of requests, rate limiting, billing, monitoring, analytics, security functions, and so on.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for routing requests in an application programming interface (API) gateway. An example method may include receiving a request from a client at the API gateway, requesting routing information for the request from a routing service associated with the request, receiving the requested routing information from the routing service, the routing information determined based at least in part on the request and a client state associated with the request, and forwarding, from the API gateway, the request to a destination based on the routing information.

In some aspects, the client state may be based on one or more of a user or a group of users associated with the request, a region associated with the request, or a storefront associated with the request. In some aspects, the routing information may be determined at least in part based on the one or more partitions assigned to the group of users. The group of users may be a pair of users, where one user is a customer associated with a customer support call, and another user is an agent associated with the customer support call.

In some aspects, determining the routing information for the request includes determining that the destination includes one or more test servers. In some aspects, the routing information includes temporary routing information corresponding to the request being during a maintenance interval, the temporary routing information different from the routing information corresponding to the request outside of the maintenance interval.

In some aspects, the method may further include verifying, at the API gateway, that the destination is within a whitelist of authorized destination, such as one or more whitelisted domains.

Another innovative aspect of the subject matter described in this disclosure can be implemented in a routing system including an API gateway. An example routing system may include one or more processors and a memory storing instructions for execution by the one or more processors. Execution of the instructions causes the routing system to perform operations including receiving a request from a client at the API gateway, requesting routing information for the request from a routing service associated with the request, receiving the requested routing information from the routing service, the routing information determined based at least in part on the request and a client state associated with the request, and forwarding, from the API gateway, the request to a destination based on the routing information.

In some aspects, the client state may be based on one or more of a user or a group of users associated with the request, a region associated with the request, or a storefront associated with the request. In some aspects, the routing information may be determined at least in part based on the one or more partitions assigned to the group of users. The group of users may be a pair of users, where one user is a customer associated with a customer support call, and another user is an agent associated with the customer support call.

In some aspects, determining the routing information for the request includes determining that the destination includes one or more test servers. In some aspects, the routing information includes temporary routing information corresponding to the request being during a maintenance interval, the temporary routing information different from the routing information corresponding to the request outside of the maintenance interval.

In some aspects, the operations may further include verifying, at the API gateway, that the destination is within a whitelist of authorized destination, such as one or more whitelisted domains.

Another innovative aspect of the subject matter described in this disclosure can be implemented in a non-transitory computer-readable medium. The non-transitory computer-readable medium stores instructions that, when executed by one or more processors of a routing system including an API gateway, cause the routing system to route requests in the API gateway by performing operations including receiving a request from a client at the API gateway, requesting routing information for the request from a routing service associated with the request, receiving the requested routing information from the routing service, the routing information determined based at least in part on the request and a client state associated with the request, and forwarding, from the API gateway, the request to a destination based on the routing information.

In some aspects, the client state may be based on one or more of a user or a group of users associated with the request, a region associated with the request, or a storefront associated with the request. In some aspects, the routing information may be determined at least in part based on the one or more partitions assigned to the group of users. The group of users may be a pair of users, where one user is a customer associated with a customer support call, and another user is an agent associated with the customer support call.

In some aspects, determining the routing information for the request includes determining that the destination includes one or more test servers. In some aspects, the routing information includes temporary routing information corresponding to the request being during a maintenance interval, the temporary routing information different from the routing information corresponding to the request outside of the maintenance interval.

In some aspects, the operations may further include verifying, at the API gateway, that the destination is within a whitelist of authorized destination, such as one or more whitelisted domains.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a request routing system, according to some implementations.

FIG. 2 shows a high-level overview of an example process flow that may be employed by the request routing system of FIG. 1.

FIG. 3 shows an example routing system, according to some of the example implementations.

FIG. 4 shows an illustrative flow chart depicting an example operation for routing requests in an application programming interface (API) gateway, according to some implementations.

Like numbers reference like elements throughout the drawings and specification.

### DETAILED DESCRIPTION

Implementations of the subject matter described in this disclosure may be used to increase the complexity of routing decisions enabled in an application programming interface (API) gateway and to extend the types of data upon which such routing decisions are made. Further, example implementations may allow for the extension of available routing decisions beyond those which are natively supported in the API gateway. For example, various implementations disclosed herein may allow for federation of routing decisions using one or more routing services coupled to the API gateway. The routing services may implement arbitrarily complex routing decisions for requests received at the API gateway, rather than being restricted to those natively supported by the API gateway. In some aspects, the routing services may process routing decisions based on one or more states associated with such requests, as represented by one or more types of data stored at the routing services. For example, such states may be based on one or more of a user or user group associated with a request, a region associated with a request, a storefront associated with a request, a time associated with a request, and so on. Allowing routing decisions to be performed by such routing services may allow for changes in routing to be implemented more frequently than with conventional API gateways, for example, such that the API gateway logic, the workflow, and other API components may remain unchanged while changes to routing are implemented by a routing service. For example, the routing decisions depend on data stored at the routing services, and such data may change much more quickly than for corresponding data stored at the API gateway itself. This may allow for the frequency with which routing decisions change to be significantly increased even without requiring changes in the routing logic itself. These, and other aspects of the example implementations are discussed further below.

Various implementations of the subject matter disclosed herein provide one or more technical solutions to the technical problem of expanding routing logic enabled by an API gateway beyond that which is natively supported by the API gateway, and allowing for more frequent alteration of states and other data upon which routing decisions are made. By allowing a routing service coupled to an API gateway to control its own routing logic, routing logic is not limited by what is natively supported in the API gateway. Further, routing decisions may be based on data stored at the routing service, such as data representing one or more states associated with a routing request. Basing routing decisions on such data may allow for changes in routing decisions to occur much more quickly than for conventional systems, even when the routing logic itself is unchanged. For example, a routing request received at the API gateway may correspond to a particular state. This state may be reflected in data stored at the routing service for the request. The data may change at the routing service as the state changes. Such states may be based on, for example, a user or group of users associated with the request, a region associated with the request, a storefront associated with the request, and so on. More specifically, various aspects of the present disclosure provide a unique computing solution to a unique computing problem that did not exist prior to electronic or online routing systems that can receive requests and determine a target domain to which the request should be forwarded based on routing logic. As such, implementations of the subject matter disclosed herein are not an abstract idea such as organizing human activity or a mental process that can be performed in the human mind.

Moreover, various aspects of the present disclosure effect an improvement in the technical field of providing robust and complex routing logic for an API gateway. The use of routing logic for receiving requests from an API gateway, determining, based on one or more states associated with the request, routing information for the request, and forwarding the request to a destination based on the routing information cannot be performed in the human mind, much less using pen and paper. In addition, implementations of the subject matter disclosed herein do far more than merely create contractual relationships, hedge risks, mitigate settlement risks, and the like, and therefore cannot be considered a fundamental economic practice.

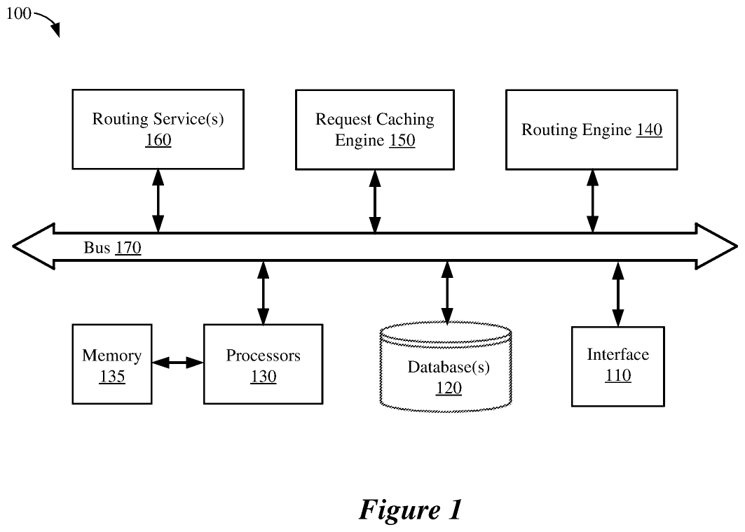

FIG. 1 shows a request routing system 100, according to some implementations. Various aspects of the request routing system 100 disclosed herein may be applicable for receiving client requests and determining corresponding routing information in a variety of applications. Such functionality may be useful not only for routing received requests but also for related protocol translations, such as by translating between web protocols such as HTTP and WebSocket and other internal protocols, among a variety of other functions. The request routing system 100 may include or perform the functionality of an API gateway.

The request routing system 100 is shown to include an input/output (I/O) interface 110, a database 120, one or more data processors 130, a memory 135 coupled to the data processors 130, a routing engine 140, a request caching engine 150, and one or more routing services 160. In some implementations, the various components of the request routing system 100 may be interconnected by at least a data bus 170, as depicted in the example of FIG. 1. In other implementations, the various components of the request routing system 100 may be interconnected using other suitable signal routing resources.

The interface 110 may include a screen, an input device, and other suitable elements that allow a user to provide information to the request routing system 100 and/or to retrieve information from the request routing system 100. Example information that can be provided to the request routing system 100 may include configuration information for the request routing system 100, such as routing, caching, and forwarding logic for one or more of the routing engine 140 and the request caching engine 150, one or more requests received for routing by the request routing system 100, information about the routing services 160, such as one or more addresses or other identification information for the routing services 160 for use by the routing engine 140, or the like. Example information that can be retrieved from the request routing system 100 may include routing information corresponding to one or more received requests, configuration information for the request routing system 100, and the like.

The database 120, which may represent any suitable number of databases, may store any suitable information pertaining to each client account registered with one or more users of the request routing system 100. For example, the information may include account information for each of the routing services 160 (such as phone numbers, email addresses, physical mailing address, billing information, and so on), and so on. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120.

The data processors 130, which may be used for general data processing operations (such as manipulating the data sets stored in the database 120), may be one or more suitable processors capable of executing scripts or instructions of one or more software programs stored in the request routing system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The routing engine 140 may receive requests from one or more request sources via the bus 160 or one or more network interfaces. The request may be received using one or more APIs. For example, each API may correspond to a type of device sending a request, and thus there may be an API for desktop computers, an API for smartphones (or different APIs for different types of smartphones), an API for tablets, and so on. The routing engine 140 may determine whether routing information for a received request is cached by the request routing system 100 (for example using request caching engine 150), and if cached, forward the request to a destination based on the cached routing information. If no routing information is cached for the request, then the routing engine 140 may determine a corresponding routing service, of the routing services 160, to the received request, and send the request to that corresponding routing service. The routing engine 140 may also receive routing information from the corresponding routing service and forward the request to a destination based on the received routing information. The routing engine 140 may also perform other functions of an API gateway, such as protocol translation, for example among web protocols such as HTTP or WebSocket and other internal protocols used within the routing service 140 or the routing services 160.

The request caching engine 150 may store and retrieve previously received routing information or destinations corresponding to requests. For example, after routing information or an address corresponding to a request is received from routing services 160, request caching engine 150 may store the routing information or destination together with a reference to the request, such as a cache key or other identifier of the request. When a request is subsequently received having the same identifier or cache key, the routing information or destination may be retrieved from the request caching engine 150 for forwarding the subsequently received request based on the cached routing information. For example, the routing information or destination may be stored in the database 120, the memory 135, or in other suitable memory included in or coupled to the request routing system 100.

The routing services 160 may be used to determine routing information for requests received by the request routing system 100. For example, the request routing system 100 may receive a request at the routing engine 140, determine that no cached routing information exists in the request caching engine 150, and determine that the request should be sent to a corresponding routing service of the routing services 160. For example, the request may indicate which routing service it is associated with, or the request routing service may determine, based on one or more rules associated with the routing engine 140, which routing service corresponds to the request. On receiving the request, the routing service of the routing services 160 may determine routing information for the request, for example, based on one or more states associated with the request, as discussed in more detail below. The routing service 160 may then send the routing information to the routing engine 140, and, as discussed above, the routing engine 140 may forward the request to a destination based at least in part on the routing information.

The particular architecture of the request routing system 100 shown in FIG. 1 is but one example of a variety of different architectures within which aspects of the present disclosure may be implemented. For example, in other implementations, the request routing system 100 may not include routing engine 140, the functions of which may be implemented by the processors 130 executing corresponding instructions or scripts stored in the memory 135. In some other implementations, the functions of the request caching engine 150 may be performed by the processors 130 executing corresponding instructions or scripts stored in the memory 135. Similarly, the functions of the routing services 160 may be performed by the processors 130 executing corresponding instructions or scripts stored in the memory 135.

Further, while the request routing system 100 is shown to include the routing services 160, in some other implementations the routing services may be coupled to but not included in the request routing system 100. For example, the routing engine 140 and the request caching engine 150 may comprise an API gateway, to which the routing services are coupled, for example via one or more buses or network interfaces.

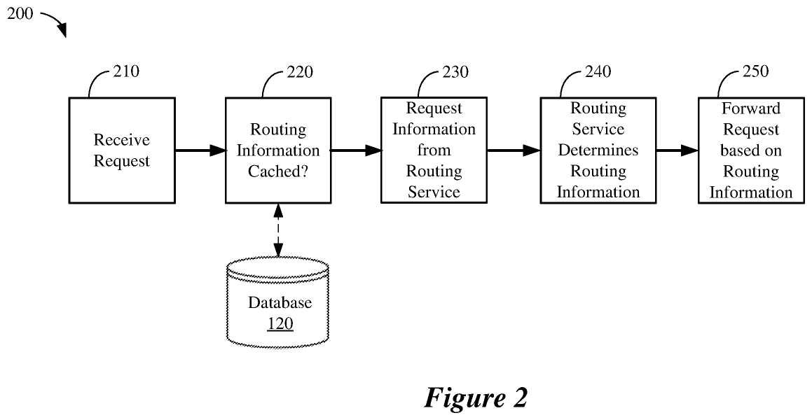

FIG. 2 shows a high-level overview of an example process flow 200 that may be employed by the request routing system 100 of FIG. 1. In block 210, a request from a client is received at the request routing system. For example, the request may be received via one or more network interfaces coupled to the request routing system 100. In block 220, the request caching engine 150 determines whether or not routing information for the received request is cached in the request routing system 100. For example, the request caching engine 150 may determine whether or not a cache key or another identifier of the request corresponds to previously cached routing information. In block 230, the routing engine 140 may request routing information from one of the routing services 160. For example, the routing engine 140 may determine, based on the received request, which of the routing services 160 to request the routing information from. For another example, the request may include one or more indicators, and the routing engine 140 may determine the appropriate routing service based on one or more of the indicators included in the request. Example indicators may include any suitable identifier, such as a company name, a service name, a brand name, or another piece of information from which the routing engine may determine the routing service. In block 240, one of the routing services 160 receives the request from the routing engine 140 and determines routing information for the request based at least in part on the request and one or more client states associated with the request. The routing service may return the routing information to the routing engine 140.

More particularly, the routing service which receives the request determines the routing information based on the request and the one or more client states. As discussed further below, such client states may be based on one or more of a user or a group of users associated with the request, a region associated with the request, a storefront associated with the request, a device type associated with the request, a network connection type associated with the request, a time associated with the request, and so on. The routing services 160 may further identify one or more destinations corresponding to the request. For example, a single destination may be identified, such as a single network address, for some implementations. For other implementations, multiple destinations may be identified for a single response. The routing services 160 may then return the determined routing information to the routing engine 140. In block 250, the routing engine 140 may forward the request to one or more destinations based on the routing information determined by the routing services 160. For example, if only a single destination is identified, then the request may be forwarded to that destination, and if multiple destinations are identified, then the request may be forwarded to a selected one of the multiple destinations.

In some aspects, the routing engine 140 may route the request to the appropriate destination determined by the routing services 160. While not shown in FIG. 2 for simplicity, in some aspects, the process flow 200 may further include receiving one or more results from the destination. The request routing system 100 may then generate a response to the request based on the received results. For example, generating the response may include aggregating the received one or more results into a single response. Generating the response may further include translating the one or more results into a suitable protocol, for example, translating the one or more results from an internal protocol into a more web protocols. The generated response may then be sent to the client which sent the initial request, for example, via one or more networks associated with the request routing system 100.

As discussed above, API gateways may be used to route requests received from a client to corresponding destinations. API gateways can also process data received from those destinations, such as aggregating received data, translating protocols, and provide the processed results to the client. Many enterprise-level APIs are deployed using API gateways, and as such, API gateways may perform tasks common to such systems, such as user authentication, rate limiting, analytics, billing services, and so on. While responding to a client request may involve complicated routing decisions, the API gateway performs such routing and invocation, while the client need only send the request. API gateways may be used in a variety of contexts. For example, a media streaming service may use an API gateway to process requests from clients, in order to generate listings of available content, recommendations, user account information, as well as to stream selected media. Similarly, an electronic commerce site may use an API gateway to generate a web page including details about a product for purchase, a service for listing buying options, for a listing of items frequently purchased with the product, displaying user reviews, and so on.

In some cases, multiple service providers may offer services through the same API gateway. For example, the API gateway may perform request routing for multiple service providers using a single API gateway. This may present problems when one service provider wishes to reconfigure their routing logic. For example, other service providers may lose access to the API gateway if the API gateway's logic is to be updated for the reconfigured routing logic. Further, the service provider wishing to reconfigure their routing logic may be limited by the routing logic natively provided by the API gateway. It would therefore be desirable to allow for more flexible implementation of routing logic for users of an API gateway without being limited by natively supported routing logic of the API gateway or by the types of data natively supported by the API gateway for implementing such routing logic.

The example implementations allow for service providers of an API gateway to implement their own routing logic without requiring alteration or reconfiguration of the API gateway itself. The example implementations may allow such service providers to control their own routing service which is coupled to the API gateway. For example such a routing service may be referred to as a “leaf system.” Requests received by the API gateway may be directed to the routing service of the appropriate service provider. The service provider may implement complex routing logic for such requests, including routing logic not natively supported by the API gateway, and based on data not natively supported by the API gateway. Such routing may be based on one or more states associated with each received request. The service provider may also reconfigure routing logic without requiring permission or involvement of the API gateway itself. While for scalability and resiliency, the API gateway may implement request caching for the requests, in some implementations, allowing the service providers to provide and run caching algorithms within the API gateway. In other implementations, the API gateway delegates routing decisions to the separate routing services.

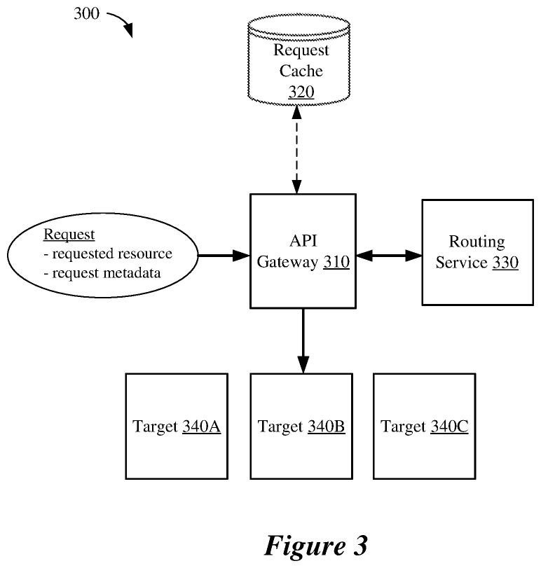

FIG. 3 shows an example routing system 300, according to some implementations. For example, routing system 300 may be an example of request routing system 100 of FIG. 1 and may perform the process flow 200 of FIG. 2. Routing system 300 is shown to include an API gateway 310, a request cache 320, a routing service 330, and a plurality of potential targets 340A, 340B, and 340C. The API gateway 310 may be an example of routing engine 140 of FIG. 3. API gateway 310 receives a request from a client requesting access to a specified resource. The requested resource may be specified by an address such as a uniform resource locator (URL). For example, a client may transmit a request to the API gateway 310 for a resource located at https://servicename.website.com/account. The request may also include one or more items of metadata about the request. For example, the metadata may indicate one or more states associated with the request, such as a user or a group of users associated with the request, a region associated with the request, a storefront associated with the request, a device type associated with the request, a network connection type associated with the request, and so on. Such information may be included in a user type header or other information item associated with the client transmitting the request.

The API gateway 310 may determine whether or not routing information for the received request has previously been cached, for example in request cache 320. For example, the API gateway 310 may query the request cache 320 using an identifier of the received request, such as using a cache key, using the requested resource, or another identifier of the request. The request cache 320 may be stored in memory coupled to the routing system 300, such as in the database 120 or memory 135 of FIG. 1. In some aspects, one or more caching algorithms used for querying the request cache 320 may be provided by a routing service 330 associated with the request, and querying the request cache 320 may include identifying a caching algorithm corresponding to the request, and running the identified algorithm to determine whether or not routing information for the received request is stored in the request cache 320.

When no routing information is cached for the received request, the API gateway may identify a routing service 330 corresponding to the received request. The routing service 330 may be one of the routing services 160 of FIG. 1. In some implementations a plurality of routing services may be associated with the API gateway 310. In some aspects, the requested resource may indicate the routing service 330, or the API gateway 310 may otherwise identify the routing service 330 based on the requested resource or the request metadata of the received request. In one example, the received request may be for a resource located at https://servicename.website.com/account, and “servicename” in the URL may indicate the routing service 330 corresponding to the request. The API gateway 310 may then forward the request to the routing service 330. The routing service 330 then determines the target or targets of the request. More particularly, the routing service 330 may determine the target or targets of the request using routing logic which may be based on one or more states associated with the request. For example, as discussed above, such states may include user or a group of users associated with the request, a region associated with the request, a storefront associated with the request, a device type associated with the request, a network connection type associated with the request, and so on. Such information may be included in a user type header or other metadata associated with the request, or may be stored at the routing service 330 itself. In the example shown in FIG. 3, the routing service 330 determines that the requested resource should be forwarded to one of the targets 340A, 340B, and 340C, and more specifically that the request should be forwarded to target 340B. The routing service 330 then sends a response to the API gateway 310 indicating the target 340B for the received request. The API gateway 310 then forwards the received request to target 340B.

Example implementations allow for complex routing decisions to be configured and reconfigured within a routing system while limiting the degree to which the logic of the API gateway itself must be altered. Individual routing services, which may be, for example, customers of an operator of the API gateway, may control routing logic for their own ecosystems without disturbing other customers of the API gateway, and without requiring permission of the API gateway.

In some implementations, a routing service may route requests based on a user or group of users associated with the request. Such information may be indicated, for example, in metadata associated with the request, such as in a user type header or other information associated with the request or may be stored at the routing service 330 as being associated with the request. For example, a routing service may route a request for a URL https://servicename.website.com/account to a different target for each user of the service, for example, the target may include account information for that particular user. In another example, a routing service may be associated with groups of users having differing levels of service, such as a free tier of users and one or more paid tiers of users. Similarly, the routing service may determine the target for the request based at least in part on the level of service associated with the group of users associated with the request. In another example, a group of users may be provided a shared workspace, and requests from users in that group may be routed to a common shard for that workspace.

Further, the routing service may identify groups of users to be routed to a common shard based on a relationship between the users in the group. For example, pairs of users may be routed to a common shard when a first user of the pair is a customer and the second user of the pair is an agent of a business associated with the routing service. Routing such pairs of users to a common shard may be used, for example for providing technical or other customer support interactions between the agent and the customer.

In some other implementations, the routing service may route requests based on a region associated with the request. For example, requests from IP addresses associated with the United States of America may be routed to a different target than IP addresses associated with the European Union. Routing such requests differently may help address regulatory and other location-specific concerns.

In addition, the routing service may route requests based on a storefront associated with the request. A routing service may be associated with a business having multiple storefronts. For example, the business may have multiple storefronts, each focusing on differing products or product categories, or may offer customized storefronts based on a user's browsing or purchase history with the business, and the routing service may direct the request to a different target based on the storefront associated with the request.

Allowing the routing service to control routing logic independently of the API gateway also allows for increased flexibility and speed in responding to maintaining and updating services. For example, a request may ordinarily be routed to one or more first servers, but if one or more of those first servers are under maintenance or being upgraded, the routing service may temporarily reassign the target of such requests to destinations not under maintenance, and then revert the target to the first servers when maintenance is complete. Similarly, when updating or developing new features for a business, it may be advantageous to select a class of users to be routed to a test server incorporating such new features. Allowing the routing service to control routing independently of the API gateway allows for simple configuration of such test traffic.

Allowing the routing services to control their own routing logic also removes much of the need to develop custom logic for the API gateway for each of the routing services. Conventional API gateways may require a great deal of customization and development and maintenance of such customized logic. Instead, such custom logic may be separately developed and maintained by the routing services.

While the routing services may control most aspects of routing logic, it may be advantageous for the API gateway to provide security features to reduce the risk of a poorly configured, or sabotaged routing service to route user request to malicious targets, such as one or more URLs serving malware or spyware. In some aspects, an API gateway may maintain a whitelist of acceptable or safe targets for requests. In other implementations, the API gateway may maintain a blacklist of unacceptable or unsafe targets for requests.

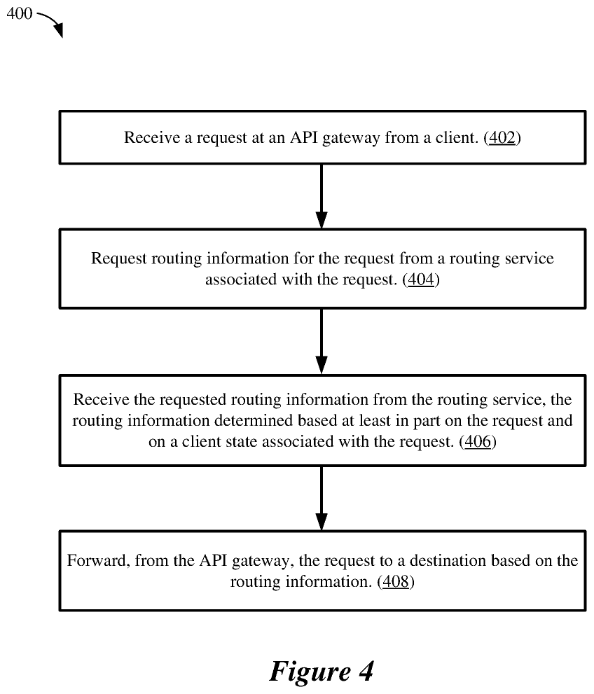

FIG. 4 shows an illustrative flow chart depicting an example operation 400 for routing requests in an application programming interface (API) gateway, according to some implementations. The example operation 400 may be performed by one or more processors of a computing device associated with the API gateway. In some implementations, the example operation 400 may be performed using the request routing system 100 of FIG. 1, or the request routing system 300 of FIG. 3. It is to be understood that the example operation 400 may be performed by any suitable systems, computers, or servers.

At block 402, the request routing system 100 receives a request at an API gateway from a client. At block 404, the request routing system 100 requests routing information for the request from a routing service associated with the request. At block 406, the request routing system 100 receives the requested routing information from the routing service, the routing information determined based at least in part on the request and on a client state associated with the request. At block 408, the request routing system 100 forwards, from the API gateway, the request to a destination based on the routing information.

In some aspects, requesting the routing information for the request in block 404 may also include determining whether or not the API gateway stores cached routing information for the request, and forwarding the request to a destination based on the cached routing information when the API gateway is determined to store the cached routing information.

In some aspects, the client state in block 406 may be based on one or more of a user or a group of users associated with the request, a region associated with the request, and a storefront associated with the request. In some aspects, the routing information may be determined at least in part based on the one or more partitions assigned to the group of users. Such a group of users may be a pair of users, where one user is a customer associated with a customer support call, and another user is an agent associated with the customer support call.

In some aspects, determining the routing information for the request in block 406 includes determining that the request is to be routed to a destination including one or more test servers. In some aspects the routing information includes temporary routing information corresponding to the request being during a maintenance interval, the temporary routing information different from the routing information corresponding to the request outside of the maintenance interval.

In some aspects, the operation 400 further includes verifying, at the API gateway, that the destination is within a whitelist of authorized destination, such as one or more whitelisted domains.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method of routing requests in an application programming interface (API) gateway, the method comprising:
receiving a request from a client at the API gateway;
requesting routing information for the request from a routing service associated with the request;
receiving the requested routing information from the routing service, the routing information determined based at least in part on the request and a client state associated with the request; and
forwarding, from the API gateway, the request to a destination based on the routing information.

2. The method of claim 1, wherein requesting the routing information further comprises determining whether or not the API gateway stores cached routing information for the request.

3. The method of claim 2, further comprising forwarding the request to the destination based on the cached routing information when the API gateway is determined to store the cached routing information.

4. The method of claim 1, wherein the client state is based on one or more of a user associated with the request, a region associated with the request, or a storefront associated with the request.

5. The method of claim 1, wherein the client state is based on a group of users associated with the request.

6. The method of claim 5, wherein the routing information is determined based at least in part on one or more partitions assigned to the group of users.

7. The method of claim 1, wherein determining the routing information for the request comprises determining that the destination comprising a test server.

8. The method of claim 1, wherein the routing information comprises temporary routing information corresponding to the request during a maintenance interval, the temporary routing information different from the routing information corresponding to the request outside of the maintenance interval.

9. The method of claim 1, further comprising verifying, at the API gateway, that the destination is within a whitelist of authorized destinations.

10. The method of claim 9, wherein the whitelist comprises a domain of authorized destinations.

11. A routing system comprising an application programming interface (API) gateway, the system comprising:
one or more processors; and
a memory storing instructions that, when executed by the one or more processors, cause the routing system to perform operations comprising:
receiving a request from a client at the API gateway;
requesting routing information for the request from a routing service associated with the request;
receiving the requested routing information from the for the routing service, the routing information determined based at least in part on the request and a client state associated with the request; and
forwarding, from the API gateway, the request to a destination based on the routing information.

12. The routing system of claim 11, wherein execution of the instructions for requesting the routing information causes the routing system to perform operations further comprising determining whether or not the API gateway stores cached routing information for the request.

13. The routing system of claim 11, wherein execution of the instructions for requesting the routing information causes the routing system to perform operations further comprising forwarding the request to the destination based on the cached routing information when the API gateway is determined to store the cached routing information.

14. The routing system of claim 11, wherein the client state is based on one or more of a user, a region, or a storefront associated with the request.

15. The routing system of claim 11, wherein the client state is based on a group of users associated with the request.

16. The routing system of claim 15, wherein the routing information is determined based at least in part on one or more partitions assigned to the group of users.

17. The routing system of claim 11, wherein the routing information comprises temporary routing information corresponding to the request during a maintenance interval, the temporary routing information different from the routing information corresponding to the request outside of the maintenance interval.

18. The routing system of claim 11, wherein execution of the instructions causes the routing system to perform operations further comprising verifying, at the API gateway, that the destination is within a whitelist of authorized destinations.

19. The routing system of claim 18, wherein the whitelist comprises a domain of authorized destinations.

20. A non-transitory computer-readable medium storing instructions that, when executed by one or more processors of a routing system coupled to an application programming interface (API) gateway, cause the routing system to perform operations comprising:
receiving a request from a client at the API gateway;
requesting routing information for the request from a routing service associated with the request;
receiving the requested routing information from the routing service, the routing information determined based at least in part on the request and a client state associated with the request; and
forwarding, from the API gateway, the request to a destination based on the routing information.
